(19) United States
(12) Patent Application Publication
(10) Pub. No.: US 2024/0292973 A1
(43) Pub. Date: Sep. 5, 2024

(54) CARTRIDGE BREWING FILTER DEVICE

(71) Applicant: Parker Roth, Naples, FL (US)

(72) Inventor: Parker Roth, Naples, FL (US)

(21) Appl. No.: 18/117,461

(22) Filed: Mar. 5, 2023

(51) Int. Cl. A47J 31/06; A47J 31/08; A47J 31/44; B01D 39/10; B01D 39/14

(52) U.S. Cl. CPC A47J 31/0668; A47J 31/0663; A47J 31/08; A47J 31/446; A47J 31/4482; B01D 39/10; B01D 39/14; B01D 2239/0618

(57) ABSTRACT

Provided is a Cartridge brewing filter device for use with a cartridge brewing system. The device aids in further filtering the beverage provided by a cartridge brewing system. The filter device also helps prevent the beverage from splashing out of the beverage container during the brewing process. Additional features include using the filter device to add flavor, tea, coffee, elements, etc to the beverage to enhance the brewing experience.

### BACKGROUND

Cartridge beverage systems like Keurig and K-Cup, Nespresso, and others have gained popularity due to their convenience and ease of use. These systems provide a quick and straightforward way to brew a single cup of coffee or tea without the need to measure and grind coffee beans or tea leaves. Instead, users can insert a pre-filled cartridge into the brewing system, press a button, and have a fresh cup of coffee or tea in seconds.

However, one of the main issues with cartridge beverage systems is that coffee grounds or tea leaves can escape from the cartridge and end up in the coffee beverage container, which can ruin the experience of enjoying a fresh cup of coffee or tea. Additionally, the high distance from which the brewed beverage falls into the beverage container can sometimes cause splashing, leaving coffee spots on the counter that require cleaning after each use.

### SUMMARY OF THE INVENTION

To address these issues, the present invention provides a novel cartridge brewing filter device that is positioned between the cartridge brewing system dispenser and the coffee beverage container. This filter device prevents coffee grounds or tea leaves from escaping the cartridge and entering the coffee beverage container, while still allowing the beverage to flow freely. Additionally, because the filter is located below the cartridge and between the cartridge brewing system dispenser and the coffee beverage container, the brewed liquid does not fall as fast into the beverage container, which eliminates the coffee spots on the counter after each use. The filter device also helps to evenly distribute the brewed beverage, resulting in a more consistent flavor and texture.

Furthermore, the present invention offers additional benefits. The filter may be filled with flavors to add a distinct flavor to the beverage, such as vanilla, caramel, or hazelnut. Alternatively, the filter may be filled with additional coffee grinds for a double brew effect, producing a stronger and bolder coffee flavor. Additionally, the cartridge brewing system may be run without a cartridge, allowing the hot water to run through the filter with the user's choice of coffee or tea, providing greater flexibility and customization to the brewing process. The present invention thus offers an improved and versatile cartridge brewing system that enhances the user's overall brewing experience with a cartridge brewing system.

Finally, the present invention provides users with additional health benefits. In an embodiment, the invention is compatible with both fibrous and paper filters, enabling a more thorough filtration of beverages. Filters with smaller pores, such as paper or fibrous filters, are effective in removing harmful substances. Given the increasing concerns over plastics and oils in our food and drinks, this feature can bring added health benefits to users.

### DESCRIPTION OF THE DRAWINGS

FIG. 1 is a perspective view of an embodiment of a cartridge brewing filter device coupled to a cartridge brewing system.

FIG. 2 is a perspective view of a Prior Art cartridge brewing system.

FIG. 3 is an exploded perspective view of a Prior Art cartridge brewing system.

FIG. 4 is a perspective view of a Prior Art cartridge brewing system.

FIG. 5 is a perspective view of an embodiment of a cartridge brewing filter device coupled to a cartridge brewing system.

FIG. 6 is a perspective view of an embodiment of a cartridge brewing filter device decoupled from a cartridge brewing system.

FIG. 7 is a perspective view of an embodiment of a cartridge brewing filter device.

FIG. 8 is a perspective view of an embodiment of a cartridge brewing filter device.

FIG. 9 is a perspective view of an embodiment of a cartridge brewing filter device.

FIG. 10 is a perspective view of an embodiment of a cartridge brewing filter device.

FIG. 11 is a perspective view of an embodiment of a cartridge brewing filter device coupled to a cartridge brewing system.

FIG. 12 is a perspective view of an embodiment of a cartridge brewing filter device coupled to a cartridge brewing system.

FIG. 13 is a perspective view of an embodiment of a cartridge brewing filter device decoupled from a cartridge brewing system.

FIG. 14 is a perspective view of an embodiment of a cartridge brewing filter device.

FIG. 15 is a perspective view of an embodiment of a cartridge brewing filter device.

### DETAILED DESCRIPTION

A few of the preferred embodiments disclosed present illustration and description. Understandably, many modifications could be made without escaping the scope of the invention. Skilled artists will appreciate the many inventive concepts that qualify as equivalents under the claims. The embodiments described below do not limit the spirit of the invention nor the claims.

Every figure does not contain every reference number. Terms such as “forward,” “rearward,” “upper,” “lower,” “bottom,” “top,” and “side” are used to reference the orientations of the invention, as shown in the images. One skilled in the art will be able to distinguish how these orientational terms could change during the use of the invention.

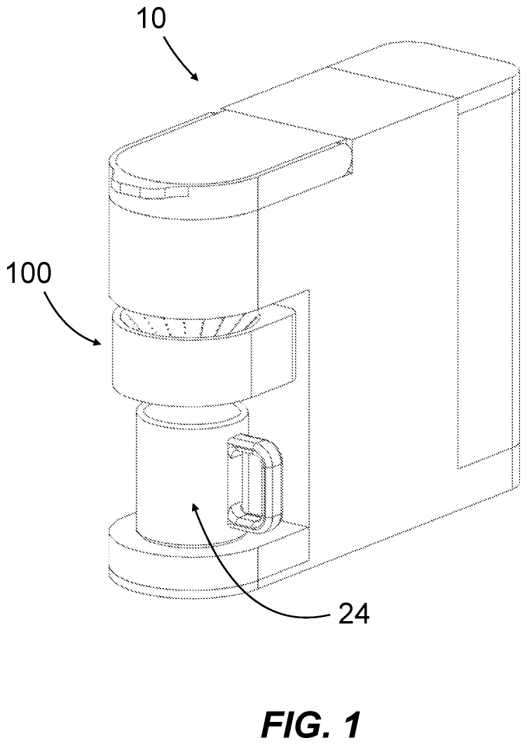

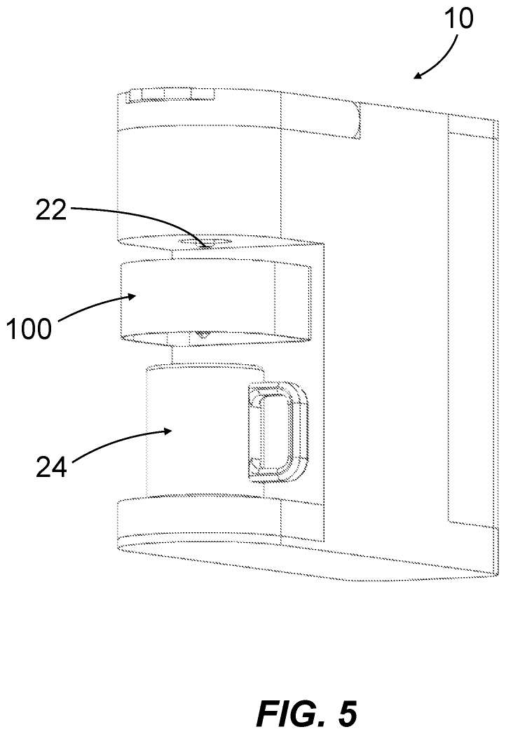

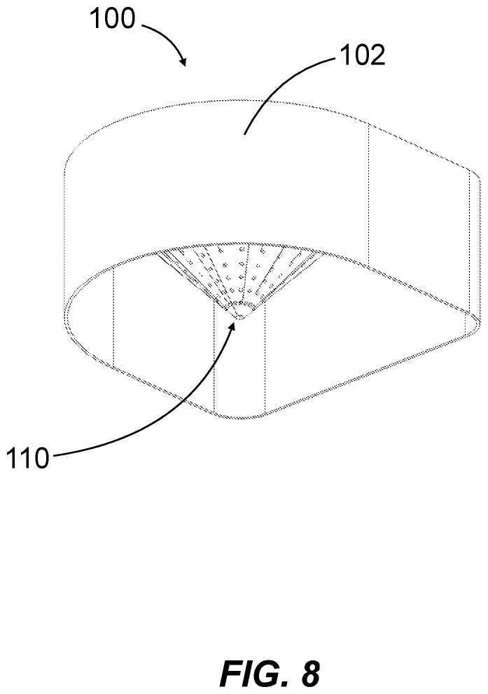

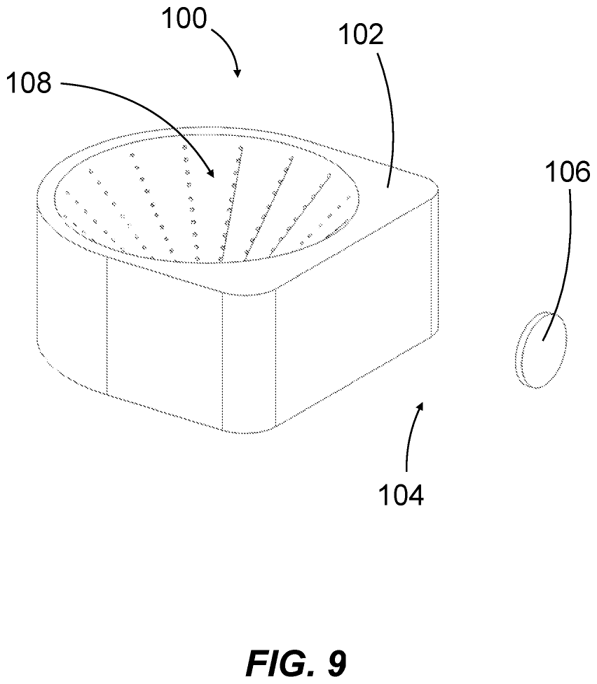

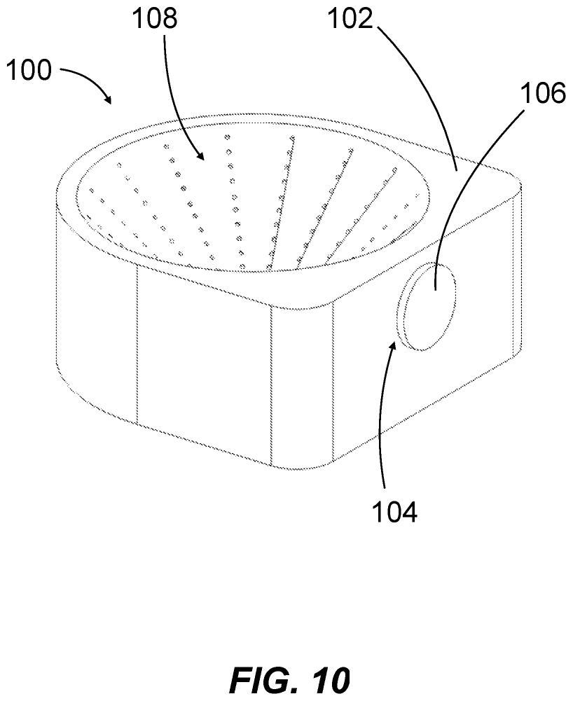

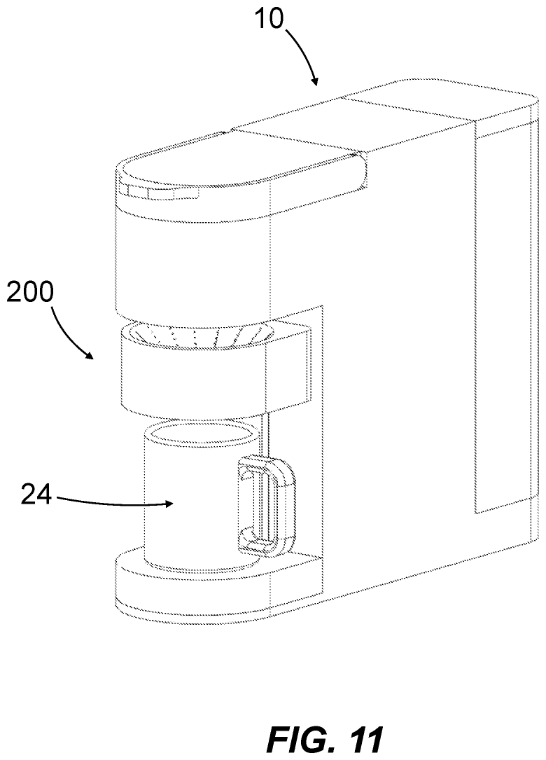

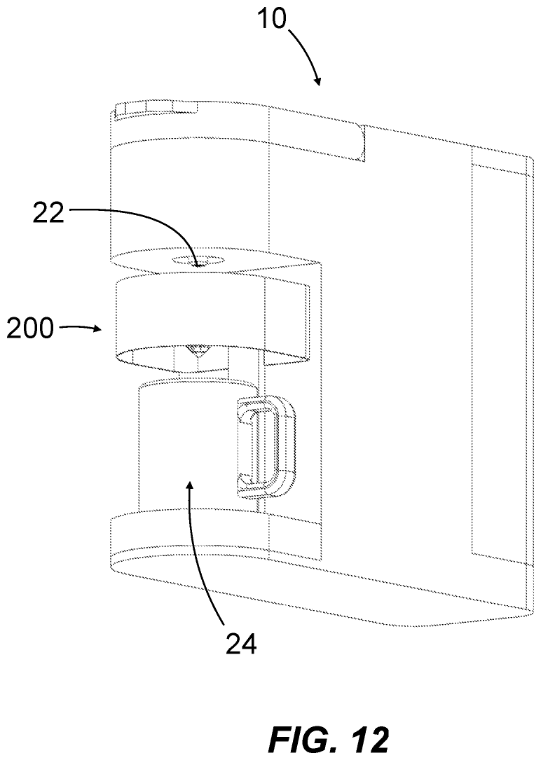

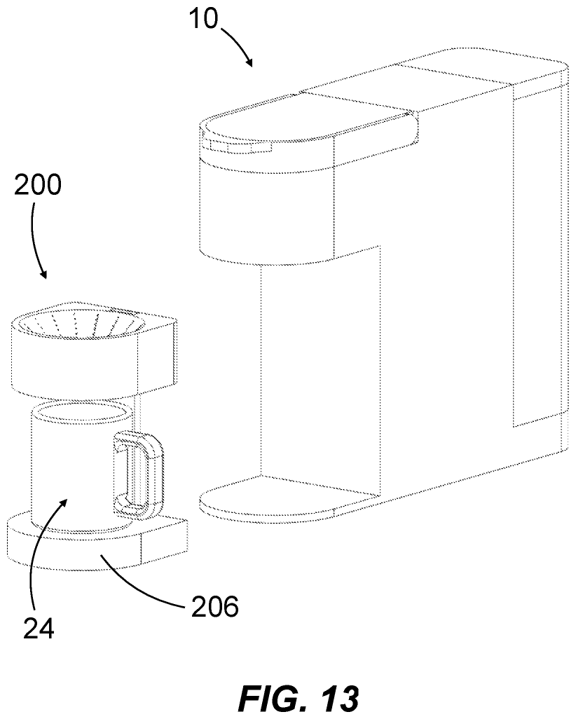

Two embodiments of the claimed invention are included in the drawings, not to limit the inventions scope but to show how elements and features may be modified to engage with the Prior Art. Embodiment cartridge brewing filter device 100 is displayed in FIG. 1, and FIGS. 5 through 10 and includes identification numbers in the range of 100-110. Embodiment cartridge brewing filter device 200 is displayed in FIGS. 11 through 15 and includes identification numbers in the range of 200-212. Prior Art that is relevant with the interaction of the invention will be referenced using identification numbers 10-24.

FIG. 1 displays a perspective view of an embodiment of a cartridge brewing filter device 100 coupled to a cartridge brewing system 10. The cartridge brewing filter device 100 is located above the beverage container 24. The cartridge brewing system 10 expels liquid into the top of the cartridge brewing filter device 100. The liquid travels through the cartridge filter brewing device 100 into the beverage container 24. By interrupting the standard fall height of the beverage from the dispenser 22, the filter body 102 reduces the speed that the beverage enters the beverage container 24 thus reducing splashing during the brewing process.

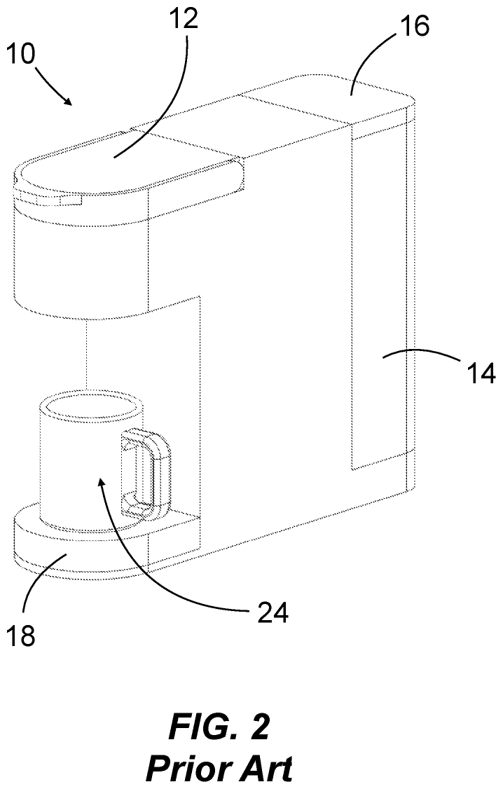

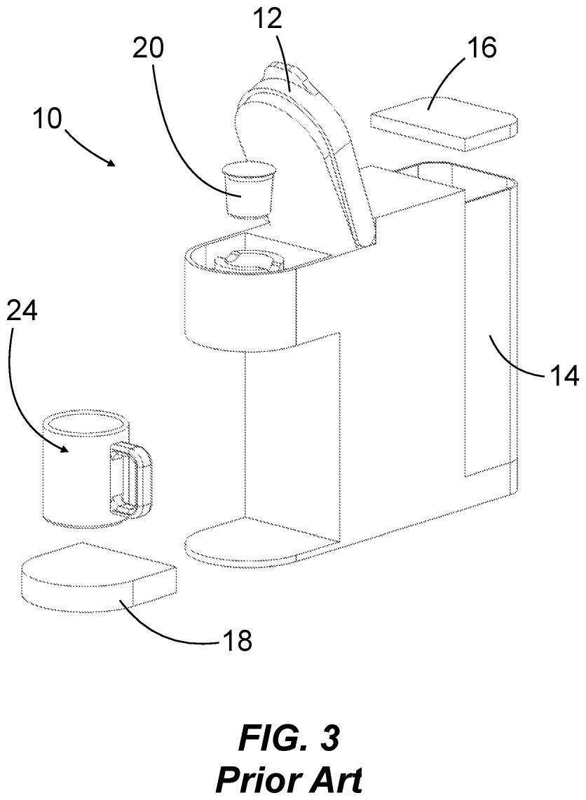

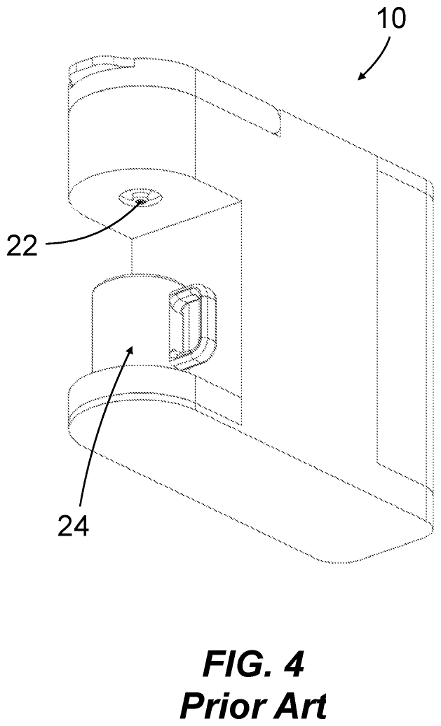

FIGS. 2 through 4 display a perspective view of a Prior Art cartridge brewing system 10. This Prior Art cartridge brewing system 10 is simplified not to illustrate how this system works from a technical prospective but rather to illustrate what constitutes a cartridge brewing system 10. A cartridge brewing system 10 is a type of coffee or beverage brewing system that uses, or is designed to use, pre-packaged cartridges, also known as pods, capsules, or discs, to brew a single serving of coffee or other beverage. It is required for these cartridge brewing systems 10 to have access to water such as water storage 14, the capacity to accept a cartridge 20, and dispenser 22 in order to function. The water storage 14 provides the cartridge brewing system 10 with water to heat up and run through the cartridge 20. The cartridge contains the material, typically but not limited to coffee grinds, that is to be brewed. The brewed liquid then leaves the cartridge and exits the cartridge brewing system 10 through the dispenser 22. Additionally, if no cartridge is present hot water will continue through the cartridge chamber and out the dispenser 22. The liquid falls from the dispenser 22 into the beverage container 24. Common features of a cartridge brewing system 10 also include but are not limited to a loading lid 12 that is lifted up to load and unload a cartridge 20, a water storage lid 16 that is removable to add more water to the water storage 14, a removable base 18 used to collect access liquid from the dispenser 22 and to give more height to a beverage container 24.

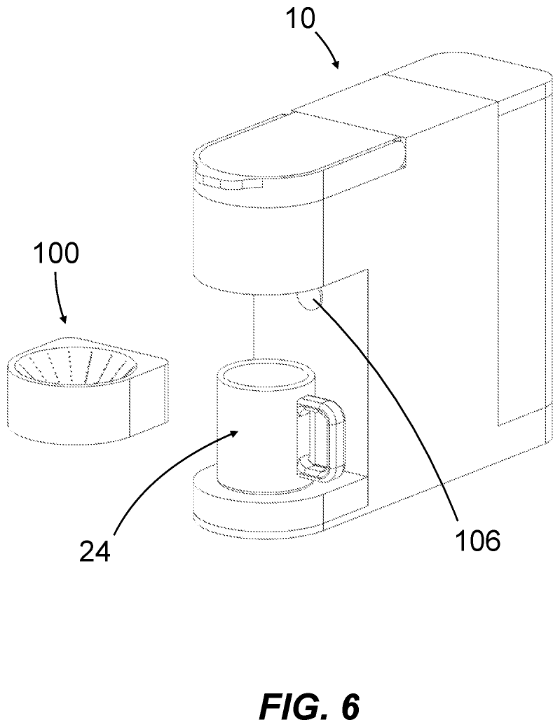

FIG. 5 and FIG. 6 display a perspective view of an embodiment of a cartridge brewing filter device 100 coupled and decoupled respectively to a cartridge brewing system 10. In this embodiment the cartridge brewing filter device 100 is comprised of a magnetic metal. A magnet with double sided tape on one side forms a taped magnetic coupling 106 to the cartridge brewing system 10. With the magnet being held by the double sided tape to the cartridge brewing system 10, the filter body 102 of the cartridge brewing filter device 100 may easily be coupled during use and decoupled after use for washing or preparing the device. The magnetic coupling between the taped magnet coupling 106 and the filter body 102 is strong enough to securely hold the filter body in place during use and weak enough that the filter body 102 may be removed from the taped magnet coupling 106 easily and without pulling the taped magnet coupling 106 off of the cartridge brewing system 10.

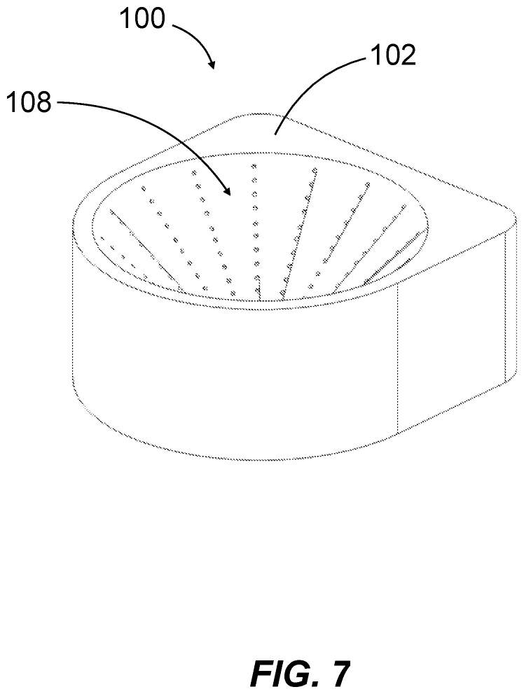

FIGS. 7 through 10 display a perspective view of an embodiment of a cartridge brewing filter device 100. Cartridge brewing filter device 100 is comprised of a filter body 102 and a connection system 104. The filter body 102 has a beverage receiving feature 108 on the top and a beverage passage feature 110 on the bottom. The beverage receiving feature 108 receives the liquid from the dispenser 22. In this embodiment it is a recessed conical shape however in other embodiment the geometry may not be conical. In this embodiment the beverage receiving feature 108 is designed to work with or without disposable paper or fibrous coffee filters. This beverage receiving feature 108 may be used to hold materials such as coffee grinds, tea leaves, or flavoring to modify the liquid after it leaves the dispenser 22 and before it reaches the beverage container 24. The liquid received by the beverage receiving feature 108 exits the filter body 102 through the beverage passage feature 110 and enters the beverage container 24. In this embodiment the beverage passage feature 110 are many small holes in the filter body 102. The small holes of the beverage passage feature 110 act as a filter to keep material other than liquid inside the filter body 102. While in this embodiment the beverage passage feature 110 are many holes, other embodiments may have, but are not limited to, one larger hole or small pours such as in a paper or fibrous coffee filter as the beverage passage feature 110. A connection system 104 couples the filter body to the cartridge beverage system 10. In this embodiment a taped magnet coupling 106 is a magnet with double sided tape on one side. The side with tape connects the taped magnet coupling to the cartridge brewing system 10. The filter body 102 comprised of magnetic metal in this embodiment magnetically couples to the taped magnet coupling 106 allowing it to couple to and from the cartridge beverage system 10. The magnetic coupling method allows the filter body 102 to be moved up or down on the taped magnet coupling to accommodate different sized beverage containers 24.

FIGS. 11 through 13 display a perspective view of an embodiment of a cartridge brewing filter device 200 coupled and decoupled respectively to a cartridge brewing system 10. In this embodiment the cartridge brewing filter device 200 is similar to the cartridge brewing filter device 100 in respect to its position and function of the filter body 202. However, in this embodiment the cartridge brewing filter device 200 has a connection system that couples the filter body 202 to the cartridge brewing system 10 by replacing at least part of the removable base 18 of the cartridge brewing system 10 with base coupling 206.

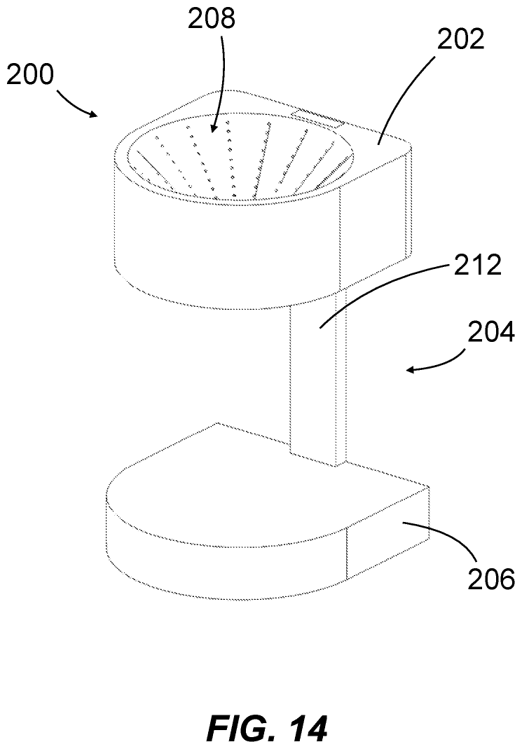

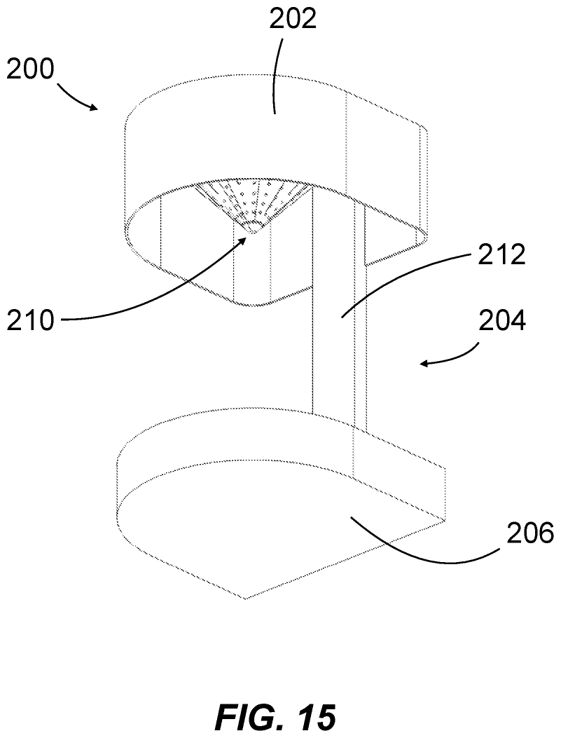

FIG. 14 and FIG. 15 display a perspective view of an embodiment of a cartridge brewing filter device 200. Cartridge brewing filter device 200 is comprised of a filter body 202 and a connection system 204. The filter body 202 is comprised of a beverage receiving feature 208 and a beverage passage feature 210 similar in function and purpose as the beverage receiving feature 108 and beverage passage feature 110 found in embodiment cartridge brewing filter device 100. In this embodiment, the connection system 204 is comprised of a base coupling 206 and a support structure 212. The base coupling 206 couples to the cartridge brewing system 10. In this embodiment the base coupling 206 replaces at least a portion of the removable base 18 on the cartridge brewing system 10. The support structure 212 extends upward and connects the base coupling 206 and the filter body 202. Although in this embodiment the support structure 212 is of a fixed height, other embodiments may exist where the height of the filter body 202 is adjustable.

It is important to note that although the embodiments depicted in the drawings may appear to be retrofitted to existing designs, the scope of the claims and the spirit of the invention extend beyond mere retrofitting. The connection system described herein can be incorporated into the body or design of a new model, creating a seamless and integrated solution. Therefore, it is vital to recognize that any such implementation of the connection system, whether in a retrofit or new model, falls under the scope of the claims and embodies the essence of the invention. By providing this flexibility in application, the invention presented here opens up new possibilities for the use of such connection systems in a variety of contexts.

What is claimed is:

1. A cartridge brewing filter device for use with a cartridge brewing system, comprising: a filter body positioned below the dispenser of the cartridge brewing system and above the beverage container; and a connection system for coupling the filter body to the cartridge brewing system, wherein the connection system comprises at least one coupling feature for engaging with the cartridge brewing system and coupling the filter body to the cartridge brewing system; and wherein the filter body has at least one beverage receiving feature and one beverage passage feature.

2. The cartridge brewing filter device of claim 1, wherein the filter body can be adjusted further or closer to the beverage container to adjust for different sized beverage containers.

3. The cartridge brewing filter device of claim 1, wherein the filter body comprises a reusable metal filter for eco-friendly brewing.

4. The cartridge brewing filter device of claim 1, wherein the filter body is a mesh material.

5. The cartridge brewing filter device of claim 1, wherein the filter body is designed to hold paper filters.

6. The cartridge brewing filter device of claim 1, wherein the filter body material comprises non-woven fibrous material.

7. The cartridge brewing filter device of claim 1, further comprising a flavor component added to the filter body during the brewing process to flavor the beverage.

8. The cartridge brewing filter device of claim 1, further comprising coffee grinds added to the filter body during the brewing process for a double brew effect.

9. The cartridge brewing filter device of claim 1, wherein at least one aperture is configured to reduce splashing of the brewed beverage out of the beverage container.

10. The cartridge brewing filter device of claim 1, wherein the filter body is easily attachable and removable from the cartridge brewing system.

11. The cartridge brewing filter device of claim 1, wherein the filter body is reusable and washable.

12. The cartridge brewing filter device of claim 1, wherein the connection system comprises a magnetic coupling for easy attachment and detachment.

13. The cartridge brewing filter device of claim 1, wherein the connection system comprises a mechanical coupling.

14. Method of using the cartridge brewing filter device of claim 1, comprising the steps of: placing the filter body below the cartridge brewing system dispenser and above the beverage container, inserting a cartridge into the cartridge brewing device system, and allowing the liquid to pass through the cartridge, out of the dispenser, through the filter body, and into the beverage container.

15. Method of using the cartridge brewing filter device of claim 1, comprising the steps of: placing the filter body below the cartridge brewing system dispenser and above the beverage container, adding flavor component or coffee grinds to the filter body, inserting a cartridge into the cartridge brewing system, and allowing the liquid to pass through the cartridge, out of the dispenser, through the filter body, and into the beverage container with the added flavor or coffee grinds.

16. Method of using the cartridge brewing filter device of claim 1, comprising the steps of: placing the filter body below the cartridge brewing system dispenser and above the beverage container, removing the cartridge from the cartridge brewing system, adding coffee or tea of the user's choice to the filter body, and allowing the hot water to exit the dispenser, pass through the filter body, and into the beverage container.

17. Method of using the cartridge brewing filter device of claim 1, the method comprising: placing a cartridge in a cartridge brewing system; positioning a filter body of the cartridge brewing filter device below the cartridge between the cartridge brewing system dispenser and a beverage container; activating the cartridge brewing system to dispense hot liquid through cartridge, out the dispenser, through the filter body, and into the beverage container; wherein the filter body reduces splashing of the brewed liquid and helps prevents coffee grounds from exiting into the beverage container.

18. A cartridge brewing filter device for use with a cartridge brewing system, comprising:
a filter body positioned below the dispenser of the cartridge brewing system and above the beverage container; and a connection system for coupling the cartridge brewing filter device to a cartridge brewing system, comprising at least one coupling element for engaging with the cartridge brewing system.

19. The cartridge brewing filter device of claim 18, wherein the connection system replaces at least a portion of the removable base of the cartridge brewing system.

20. Method of using the cartridge brewing filter device of claim 18, comprising the steps of: removing the removable base from the cartridge brewing system, connecting the cartridge brewing filter device to the cartridge brewing system using the base coupling which places the filter body below the cartridge brewing system dispenser and above the beverage container, inserting a cartridge into the cartridge brewing system, and allowing the liquid to pass through the cartridge, out of the dispenser, through the filter body, and into the beverage container.
